(19) United States
(12) Patent Application Publication
(10) Pub. No.: US 2014/0038721 A1
(43) Pub. Date: Feb. 6, 2014

(54) METHOD AND SYSTEM FOR FACILITATING ONLINE SOCIAL INTERACTIONS VIA COOPERATIVE GAMEPLAY

(71) Applicants: Christopher R. Archer, Sammamish, WA (US); Dusty H. Welch, Camarillo, CA (US)

(72) Inventors: Christopher R. Archer, Sammamish, WA (US); Dusty H. Welch, Camarillo, CA (US)

(21) Appl. No.: 13/566,907

(22) Filed: Aug. 3, 2012

(51) Int. Cl. A63F 13/12

(52) U.S. Cl. CPC A63F 13/12
USPC 463/42

(57) ABSTRACT

A method for facilitating interactions between a first user and a second user connected to a network is disclosed. The method includes engaging the first user in a first activity over the network; receiving a request for cooperation from the first user with regard to the first activity; alerting the second user about the request from the first user; receiving over the network feedback from the second user indicating progress in a second activity; and providing cooperation to the first user with the first activity in response to the feedback received from the second user.

### FIELD

The present invention relates generally to facilitating online social interactions via cooperative gameplay, and more particularly, to providing a network-based in-game cooperation system that enables and encourages players to request and receive assistance from each other, either synchronously or asynchronously.

### BACKGROUND

Given the tremendous growth of social networks relying on online media such as Facebook and Twitter in recent years and the popularization of mobile devices such as smartphones, it has never been more important for people to feel connected to and be able to interact with others in their social circles on a regular basis. For those who are fans of video games, network-based multiplayer gaming has provided a natural way to bond with other gamers while sharing the excitement from the gaming experience.

Currently, most gaming platforms such as personal computers (PC), video game consoles (e.g., Sony PlayStation®, PSP®, Nintendo Wii®, DS®, and Microsoft Xbox®), and portable devices (e.g., Apple's iPhone®) offer many games in different genres that support at least one network-based multiplayer mode. Typically, to participate in the network-based multiplayer mode of a game, players are required to run the game on the same platform. To initiate a multiplayer game session, each player can log onto a central server hosting the game from their respective gaming devices (e.g., PCs or game consoles). A new game session may start after all participating players have successfully signed in. Some games allow players to join an ongoing game session after the session has already started. Depending on the game, the multiplayer mode can be either a cooperative mode where multiple players to team up achieve a common goal in the game or a “versus” mode where players play against each other.

Although existing video games with network-based multiplayer modes allow players to enjoy and share their gaming experience with friends, which in turn can help strengthen the friendship among the players, their role as a medium or tool for facilitating online social networking and relationship building is constrained by the way in which the multiplayer mode operates conventionally. In particular, games with a multiplayer mode are often platform-dependent and/or game-specific. That is, they require the players to run the same game on the same gaming platform and/or logging onto a dedicated gaming network. For example, two players who wish to play the popular New Super Mario game together online each have to have a copy of the game, a Nintendo Wii game console, and be connected to the Nintendo network to play the online multiplayer mode of the game. This prevents their other friends who either do not own the game or a Nintendo Wii console from joining them in the same game session because that particular Mario game only runs on Nintendo's Wii console and network.

Accordingly, players playing on different devices or platforms may have a difficult time connecting with each other using the multiplayer gaming modes offered in existing games. Even if the players all have the requisite equipment, they may not be interested in the same game. For example, a player who is a fan of sports games may not choose to join his friends online to play a first shooter game, and vice versa. Similarly, casual gamers who are only interested in relatively simple and quick games (e.g., games on their mobile phones) would be less willing to spend considerably longer periods of time with more devoted gamers in a multiplayer game session. In short, as a tool for building and enhancing one's social network, the current network-based multiplayer gaming platform has a very limited reach in terms of the type of participants it can attract and connect.

Embodiments of the present invention provide a unique interactive network-based gaming experience that can reach a larger audience and encourage more frequent interactions among the participants than what can be provided by the existing multiplayer gaming networks.

### SUMMARY

The present invention relates to systems and methods for providing a cooperation and gameplay system in a network-based multiplayer gaming environment that facilitates interactions among players (and their non-gaming friends). In general, a player participating in a multiplayer game session can send out a request for cooperation during the game using the various embodiments of the system to people who are linked to him through online social media or the gaming network. One of more of the recipients of the player's cooperation request can respond by performing certain tasks, such as playing a mini-game or visiting the player's profile, on their own devices. The player can receive a boost in the game, synchronously or asynchronously, as a result of his friends' performing these tasks. Synchronous cooperation is provided when the player is in a game session. Asynchronous cooperation is provided when the player is not in a game session. In return, his friends can also be rewarded, for example, in the form of social currency for helping the player with his game.

Essentially, the disclosed system allows friends in the player's social network to provide in-game cooperation to the player without having to actually join the same game session or play the same game. It also removes the hardware and platform restrictions of existing multiplayer gaming networks so that people using different devices running different operating systems/games can still be connected through providing cooperation to each other over the gaming network. Thus, it can extend the reach of the gaming network to a different audience group. Because both the sender and receiver of a cooperation request can benefit from utilizing the unique cooperation and gameplay system disclosed in the various embodiments of the invention, they are encouraged to interact more often with each other using the gaming network. As a result, it can help increase the popularity of the network and strengthen the bonding among its members.

### BRIEF DESCRIPTION OF THE DRAWINGS

FIG. 1 illustrates the exemplary components of a network for supporting a synchronous/asynchronous cooperation and gameplay system according to embodiments of the invention.

FIG. 2 illustrates the exemplary components of a computer that can serve as the database server and/or game server in a gaming network according to embodiments of the invention.

FIG. 3 illustrates the interactions between two players connected to a gaming network in an exemplary process of using the synchronous/asynchronous cooperation and gameplay system according to embodiments of the invention.

FIG. 4 illustrates an exemplary screen shot on a player's PC according to embodiments of the invention.

FIG. 5 illustrates an exemplary screen shot on a player's mobile device according to embodiments of the invention.

FIG. 6 illustrates the interactions among multiple players using the synchronous/asynchronous cooperation and gameplay system according to embodiments of the invention.

FIG. 7 is a flow chart illustrating exemplary steps taken by one player on a multiplayer gaming network utilizing the synchronous/asynchronous cooperation and gameplay system according to embodiments of the invention.

FIG. 8 is a flow chart illustrating exemplary steps taken by another player on a multiplayer gaming network utilizing the synchronous/asynchronous cooperation and gameplay system according to embodiments of the invention.

FIG. 9 is a flow chart illustrating exemplary steps taken by yet another player on a multiplayer gaming network utilizing the synchronous/asynchronous cooperation and gameplay system according to embodiments of the invention.

### DETAILED DESCRIPTION

In the following description of preferred embodiments, reference is made to the accompanying drawings which form a part hereof, and in which it is shown by way of illustration specific embodiments in which the disclosure can be practiced. It is to be understood that other embodiments can be used and structural changes can be made without departing from the scope of the embodiments of this disclosure.

The present invention relates to systems and methods for providing a cooperation and gameplay system in a network-based multiplayer gaming environment that facilitates interactions among players (and their non-gaming friends). In general, a player participating in a multiplayer game session can send out a request for cooperation during the game using the various embodiments of the system to people who are linked to him through online social media or the gaming network. One of more of the recipients of the player's cooperation request can respond by performing certain tasks, such as playing a mini-game or visiting the player's profile, on their own devices. The player can receive a boost in the game, synchronously or asynchronously, as a result of his friends' performing these tasks. Synchronous cooperation is provided when the player is in a game session. Asynchronous cooperation is provided when the player is not in a game session. In return, his friends can also be rewarded, for example, in the form of social currency for helping the player with his game.

Essentially, the disclosed system allows friends in the player's social network to provide in-game cooperation to the player without having to actually join the same game session or play the same game. It also removes the hardware and platform restrictions of existing multiplayer gaming networks so that people using different devices running different operating systems/games can still be connected through providing cooperation to each other over the gaming network. Thus, it can extend the reach of the gaming network to a different audience group. Because both the sender and receiver of a cooperation request can benefit from utilizing the unique cooperation and gameplay system disclosed in the various embodiments of the invention, they are encouraged to interact more often with each other using the gaming network. As a result, it can help increase the popularity of the network and strengthen the bonding among its members.

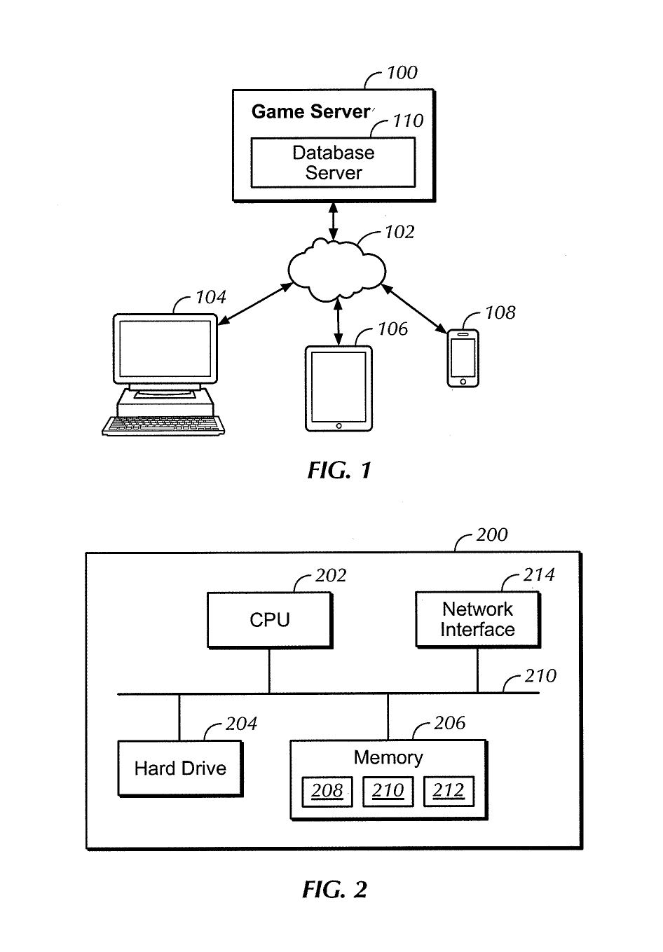

FIG. 1 illustrates an exemplary network 102 including a central game server 100 for facilitating a synchronous or asynchronous cooperation and gameplay system for one or more network-based multiplayer video games. Games that can be supported by the central game server 100 can include, but not limited to, shooter (e.g., first-person and third-person), fighting, action-adventure, racing, sports, rhythm (e.g., music), strategy, and role-playing games (RPG). The games can be played in either an asynchronous single player mode on an individual device connected to the network or a multiplayer mode using multiple devices on the network as remote terminals.

In the embodiment illustrated in FIG. 1, the game server 100 can include a database server 110 for storing information associated with the games hosted by the network. In another embodiment, the game server 100 and the database server 110 can be two separate physical servers. The information stored in the database server 110 can include individual player's account information, saved game data, in-game attributes such as the player's score, experience level, health level, weapons, skills, items, etc., and historical ranking on the gaming network for a particular game. Some of the information, such as the in-game attributes can be updated in real time during gameplay. The account information can include, for example, the player's username, password, age, favorite genres/games, preferred gaming platform (e.g., PC, gaming console, or mobile device), etc.

In addition, the database server 110 can maintain a record of each player's personal network of friends and their contact information. Although the term “friend” is used throughout this document, it should be understood that the player's personal network can include other types of contacts such as relatives and coworkers and that the term “friend” is used for generally describing all types of social relationships. A player's personal network can include other players on the network and non-gamers who do not usually participate in multiplayer game sessions hosted on the network. In one embodiment, the game server 100 can provide an interface for a player to add and remove contacts from his personal network. Additionally or alternatively, a player's contacts from other online social networks (e.g., Facebook) and/or stored in his personal devices (e.g., cellular phone) can be imported to the database server 110. Each contact in the player's network can have an associated address at which he or she can receive from, and send messages to, the game server 100. The address can be an IP address for a PC or a game console, a phone number of a mobile device, an email address, a social network account, etc. In one embodiment, each person on the network can have multiple addresses and an alert from the system can be sent to one or more of these addresses. This can ensure that the alert will reach the recipients quickly, thus reducing the response time from the recipients. Details of the transmitting and receiving of cooperation alerts will be discussed in detail below.

Referring back to FIG. 1, multiple client devices 104, 106, 108 can be connected to the game server 100/database server 110 via a computer network 102. Although only three client devices 104, 106, 108 are shown in FIG. 1, it should be understood that the network 112 can be configured to support a different number of client devices. The client devices connected to the network 112 can include a variety of different types of devices such as PCs, Macs, video game consoles, portable game consoles, other portable electronic devices such as smartphones, cellular phones, and tablet PCs, or any other types of devices compatible with the network. Some of the devices may be of the same type. Not all the client devices have to support all or any of the multiplayer games hosted on the game server 100.

In this embodiment, client device 104 can be Player A's PC from which he can log onto the gaming network to play multiplayer video games. Client device 106 can be Player B's tablet PC which can also be used to log onto the gaming network to play games. Client device 108 can be Player C's smartphone which is also connected to the network 112. In some embodiments, at least a portion of the multiplayer games on the network can be installed on the game clients 104, 106, 108. Alternatively or additionally, at least a portion of the game can be installed on the game server 100. It is not required that all client devices can be used as a game console for playing the multiplayer video games on the game network. As will be discussed below, even if a client device does not directly support any of the multiplayer video games on the network, it can still be a part of the cooperation and gameplay system for providing synchronous or asynchronous cooperation to other players on the network. This allows a player's friends to be able to send help to him using a wide range of devices not limited to PCs and video game consoles.

The computer network 102 can be any existing network including, but not limited to, a local area network (LAN), wide area network (WAN), cellular network, WiFi network, and other wireless networks suitable for supporting network-based multiplayer video games and communications among the client devices 104, 106, 108 and the game server 100. Preferably, the network 102 can interface with different types of devices including one or more of PCs, Macs, video game consoles, and tablet PCs, smartphones, and other types of mobile devices. In some embodiments, the network 102 can be a public network such as the internet. In other embodiments, the network 102 can be a dedicated network (e.g., a virtual private network (VPN)) set up for the sole purpose of supporting network play of one or more video games. The network 102 can be scalable so as to connect players from different locations in the world.

The game server 100/database server 110 can be one or multiple servers hosted at one or more locations on the network 102. The game server 100/database server 110 can include some of the components of a typical computer. FIG. 2 illustrates the exemplary components of a computer that can be used as the database server 110 and/or the game server 100. In some embodiments, the client devices 104, 106, 108 can also include the same or similar components shown in FIG. 2. As illustrated, the computer 200 can include a central processing unit (CPU) 202, hard disk drive 204, memory 206, and network interface 214, all of which can be connected to each other via a system bus 210. The game server 100/database server 110 can perform one or more operations including, for example, hosting one or more multiplayer video games on the network 102, authenticating players, receiving in-game cooperation requests from one or more players, alerting the player's friends that the player is in need of cooperation, receiving responses from the player's friends, and providing in-game cooperation to the player based on the responses received from his friends. These operations can be performed by the processor 202 executing software programs stored in the memory 206 (or other types of storage devices such as the hard disk drive 204) of the computer 200.

In some embodiments, one or more programs for running the video games and facilitating communication between multiple client devices can also be stored and/or transported within any non-transitory computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer-readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

In this embodiment, as illustrated in FIG. 2, one or more programs 208, 210, 212 required for supporting the video games and facilitating communications among multiple client devices can be stored in the memory 206 of the computer 200. As mentioned above, the database server can include a database program for tracking player data including a player's in-game attributes and a list of people who are linked to him and their contact information. Other programs stored in memory 206 can include, for example, a program for registering new players and authenticating existing players, a program for maintaining a profile for each player, a program for identifying each player's contacts on the network, a program for communicating with client devices connected to the network, a program for determining the type and/or amount of cooperation to be given to a player based on his friends' responses to his cooperation request, and a program for determining the type/amount of reward for the player's friends for helping the player with his game. The network interface 214 can be capable of communicating with different types of client devices using one or more known network protocols.

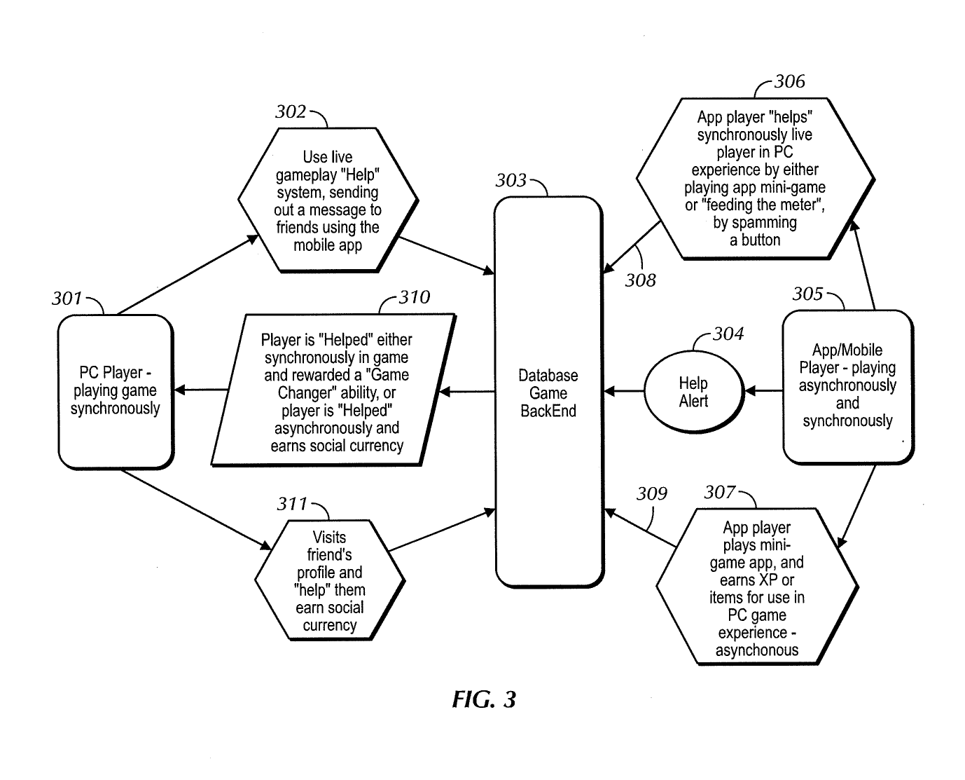

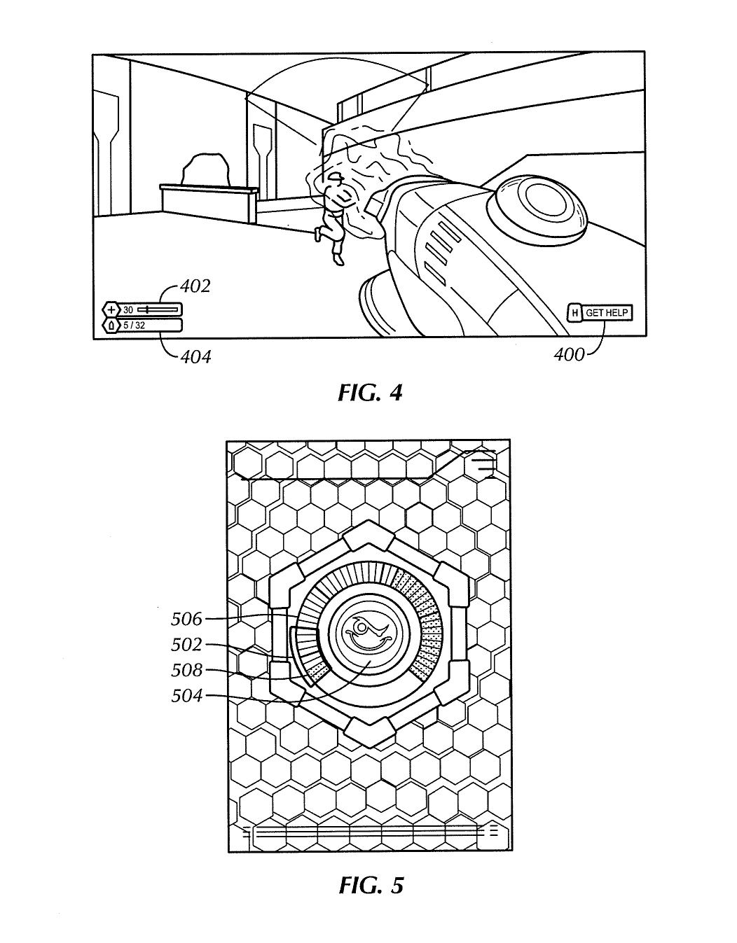

FIG. 3 illustrates an exemplary process of a PC player requesting and receiving cooperation from one of his friends during an online game session using the cooperation and gameplay system according to an embodiment of the invention. As illustrated in FIG. 3, PC Player can be one of the players engaging in a network-based multiplayer video game session hosted by a game server on a network such as the one illustrated in FIG. 1. PC Player can be playing the game from his PC synchronously with one or more other players on the network (301). It should be understood that, in other embodiments, the player can be playing the game on another type of gaming devices such as a video game console or a portable gaming device. The game can be any video game of any genre that supports a network-based multiplayer mode. For example, FIG. 4 illustrates an exemplary screen shot of a first-person shooter game being played on a PC.

Referring back to FIG. 3, when PC Player encounters difficulties in the game, he can activate a live cooperation system to request cooperation from his friends via the network (302). For example, in the first person shooter game shown in FIG. 4, a “Get Cooperation” option 400 can be displayed on the screen when the health bar 402 of the player dips below a predetermined level, indicating that the player is in danger of being eliminated in the game. It should be understood that, in various embodiments, the “Get Cooperation” option 400 can become available under one or more different conditions including, for example, when the player reaches a certain score and when a player is about to run out of ammunition. In some embodiments, the “Get Cooperation” option 400 can be available to the player at all time during the game. In one embodiment, multiple “Get Cooperation” options can be displayed on the screen, each indicating a different type of cooperation available for request. For example, there can be both a “Get Ammunition” option and an “Improve Health” option available at the same time.

In the embodiment illustrated in FIG. 4, to activate the “Get Cooperation” option 400, the PC Player can simply click on it without pausing the game. In other embodiments, the “Get Cooperation” option can be activated using other well-known means such as by the player pressing a hotkey or a combination or a sequence of keys on the keyboard of a PC or buttons on a controller. It can also be activated verbally or in response to the player's movement detected by a camera and/or sensors connected to a game console.

Referring back to FIG. 3, by activating the “Get Cooperation” option, PC Player can send out a message to the game server/database server requesting cooperation from his friends (302). In one embodiment, the message can indicate the type of cooperation being requested by PC Player if more than one type of cooperation is available to him. After the message reaches the game server, the game server can look up one or more of PC Player's friends from the database and generate a cooperation alert to be sent to them (303) immediately. The cooperation alert can be sent to each of the friends at the corresponding address(es) stored in the database (304). In one embodiment, the database can also indicate whether each friend has elected to receive a cooperation alert from PC Player and the cooperation alert can be sent to only those who have agreed to receive alerts. Additionally or alternatively, the game server can use various algorithms to select from players registered on the network recipients of the cooperation alert. The selected recipients can include those who are not connected to PC Player. This can provide a way of introducing new friends to PC Player.

The cooperation alert can then be sent via the network to one or more of PC Player's friends (304). In various embodiments, the cooperation alert can be transmitted in any suitable form such as a text message, email, tweet, voice message, social media alert, etc. The alert can appear on the recipient's devices as a pop-up alert, an icon indicating an unread email, or a voice alert such as a unique ringtone. In the embodiment illustrated in FIG. 3, one of PC Player's friends, Mobile Player, can receive the cooperation alert in the form of a text message on his mobile device (e.g., a smartphone) (305). In response to the cooperation alert, Mobile Player can activate a mini-game on his mobile device and start to play the mini-game (306). In some embodiments, Mobile Player may have a time limit for providing cooperation.

FIG. 5 illustrates a screen shot of an exemplary mini-game. As illustrated, this mini-game displays a round power/accuracy bar 502, similar to the one commonly found in golf games. Mobile Player can press the button 504 to start a round, which can set the power/accuracy bar in motion. Mobile Player can then attempt to hit the button 504 again when the bar 502 is in zone 1 506 and yet again when the bar is in zone 2 508. The accuracy of Mobile Player's button presses can determine his score. His score can be transmitted back to the game server (308) and converted to cooperation for PC Player in his game. It should be understood that, in various embodiment, Mobile Player can be asked to perform tasks other than playing the mini-game shown in FIG. 5 to provide cooperation to PC Player. For example, in one embodiment, Mobile Player can play a different “Feed the Meter” game that requires Mobile Player to spam a button on the screen. In another embodiment, the Mobile Player can be directed to visit PC Player's social network profile. In yet another embodiment, the Mobile Player can be asked to complete an online survey.

Referring again to FIG. 3, alternatively, Mobile Player and PC Player can be the same player. By playing a mini-game or performing other tasks on his mobile device while not playing the network game on his PC, the player can accumulate experience, items, and other types of rewards for use when he plays the network game on his PC at a later time (307). Similarly, his progress in the mini-game (or other tasks) can be sent to and stored at the game server (309). This process can be referred to as providing asynchronous cooperation as the cooperation from playing the mini-game is not received at the same time that the network game is being played at this PC.

Although only one Mobile Player is illustrated in FIG. 3, any number of Mobile Players can respond to PC Player's request for cooperation. The game server can record and convert the scores (or other forms of responses) received from all responding Mobile Players to determine the type and/or amount of cooperation to be given to the PC Player. In various embodiments, the types of cooperation can include, but not limited to, refilling the health bar, increase of ammunition, upgrade in weapon, and making available advanced skills and/or items to PC Player. Preferably, the more friends responding to PC Player's cooperation request, the more cooperation he can receive in the game.

As illustrated in FIG. 3, PC Player can be helped either synchronously or asynchronously (310). When the cooperation is being provided synchronously, Player PC can receive cooperation from Mobile Player (and other friends) dynamically as Mobile Player (and other friends) plays the mini-game (or performs other tasks) on his mobile device. For example, in the game shown in FIG. 4, the health bar 402 for PC Player can be filled immediately after the game server determines that Mobile Player has successfully achieved a certain score in the mini-game. Additionally or alternatively, the ammunition tracker 404 can be updated from “30/120” to “120/120.” Additionally or alternatively, PC Player can receive other types of helps such as becoming temporarily invincible in the game.

In contrast, when the cooperation is provided in an asynchronous fashion, PC Player may not receive any instant upgrade in one or more of his in-game abilities. Instead, he may be given the option to utilize the experience or items earned from his previous playing of mini-games (or performing other tasks) on his mobile devices at a later time. In some embodiment, asynchronous cooperation can also be provided by people other than the player himself. For example, Mobile Player may not respond right away after receiving the cooperation alert. Nevertheless, he can still play the mini-game (or perform other requisite tasks) at a later time to earn experience, items, or other types of cooperation for PC Player to use when PC Player participate in the multiplayer game online at a later time. Additionally or alternatively, asynchronous cooperation provided by friends or the player himself can be converted into other virtual rewards such as social currency which can be used outside of the video games.

To encourage PC Player's friends to respond to his cooperation requests, PC Player can either return the favor when his friends request for cooperation when playing a game or perform one or more other tasks online to benefit his friends. For example, PC Player can visit his friends' online profiles/websites, sign up to receive tweets from the friends, or introduce new friends to his friends to help them increase their profiles/popularities online and/or earn them social currency (311).

As described in the embodiments above, Mobile Player does not have to participate in the same game session as PC Player to provide cooperation to PC Player. Instead, Mobile Player can simply perform a separate task such as playing a mini-game on his own device as means for responding to PC Player's request for cooperation. This allows all PC Player's friends to cooperation him with his game even if they do not have the compatible gaming platform or the interest to participate in the game. This way, even those friends who are non-garners can feel connected to their gaming friends, and vice versa.

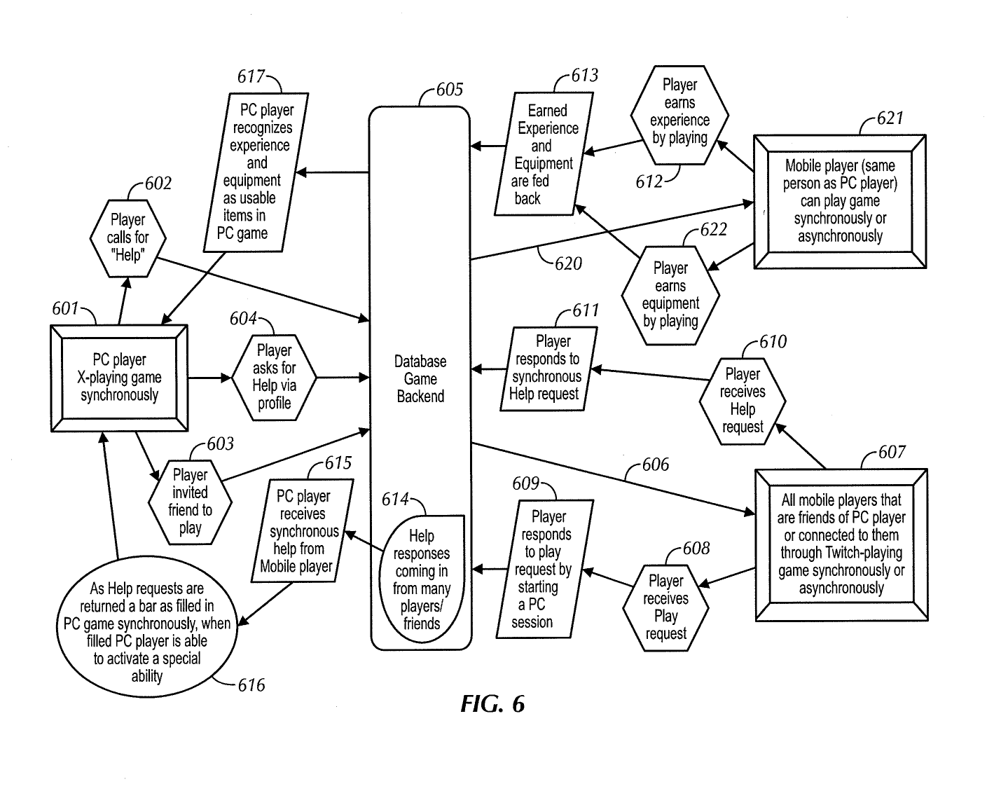

FIG. 6 is another diagram illustrating the interactions among a network of friends using an embodiment of the synchronous/asynchronous cooperation and game play system of the present invention. More specifically, FIG. 6 illustrates PC Player X requesting and receiving synchronous and/or asynchronous cooperation from multiple mobile players including himself over a network supporting an embodiment of the cooperation and game play system of the present invention.

As illustrated, PC Player X can be playing a network-based video game on his PC (601). During the game, he can call for cooperation by, for example, hitting a hotkey or clicking on a button displayed on the screen (602). Additionally or alternatively, PC Player X can invite his friends to play cooperative with him in the game. The invitation can be sent online over the gaming network or offline using other communication means (603). Additionally or alternatively, PC Player X can ask for cooperation via his profile on the gaming network or other social media (604). PC Player X's requests and/or invitations can be routed through a game server (e.g., the game server shown in FIG. 1) hosting a database and the game backend to the recipients (605). As in the embodiments discussed above, the game server can perform a number of tasks such as looking up the addresses of each of the recipients and reformatting the requests and/or invitations so that they can be received on the recipients' devices.

Properly formatted messages (e.g., cooperation alerts) can then be sent to all mobile players who are either friends of PC Player X's or connected to him via a particular game (606). One or more of these mobile players can also be playing the same game, either synchronously or asynchronously, with the PC Player X (607). One of more of the mobile players can receive an invitation (e.g., play request) to join PC Player X in his game session, if they have not done so already (608). These mobile players can respond to the play request by logging into the PC Player X's game session (609). Other mobile players may receive a request for cooperation from PC Player X (610). They can respond by performing one of the tasks on their mobile device, such as playing a mini-game or visiting PC Player X's profile (611).

Additionally or alternatively, a message can be sent to PC Player X's own mobile device (620). In response, PC Player X can play a game on his mobile device either synchronously or asynchronously with respect to his PC game session (621). In one embodiment, PC Player X can play a mobile version of the same game on his mobile device to earn experience, credits, and/or items that can be used in the PC game sessions (612, 622). The experience, credits, and/or items earned through playing on his mobile device can be transferred to and stored in his PC game account on the game server (613).

The various types of feedbacks from other mobile players including their synchronously participation in the PC game session 609 and results from playing mini-games on their mobile devices 611 along with the experiences and items earned by PC Player X himself through playing the mobile game can be tracked by the game server and converted to one or more types of in-game cooperation for PC Player X in his PC game session (614). PC Player X can receive cooperation synchronously as the other mobile players respond to his cooperation request (615). For example, his health bar can be refilled as a result of his mobile player friends completing a level in their mini-games (616). With full health, PC Player X can activate a special ability in the PC game session. Other rewards or helps can also become available to PC Player X as his mobile player friends continue to play the mini-games (or perform other tasks) on their devices. In addition, the experience and items earned through his own asynchronous playing on his mobile device can also be available to the PC Player X for use in his PC game session (617).

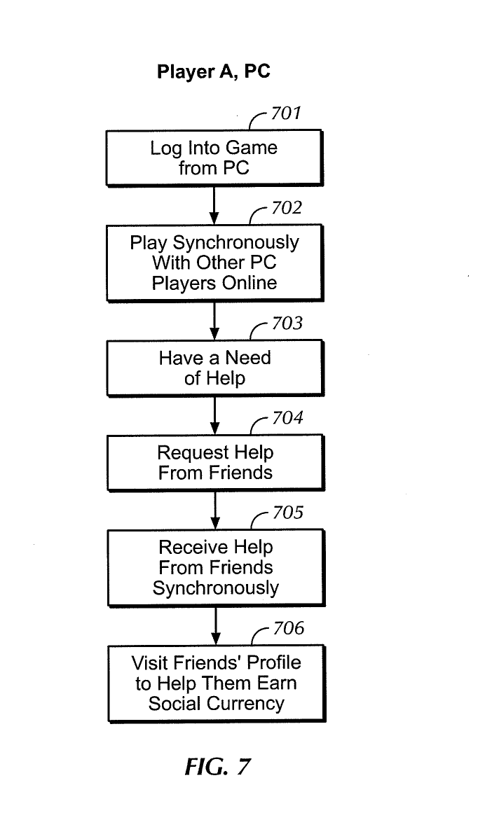

FIGS. 7-9 are flowcharts illustrate exemplary steps in an embodiment of the invention from the prospective of three players playing games on their respective devices. It should be understood that, although the embodiment of FIGS. 7-9 only illustrates the interactions among the three players, the embodiment does not have to be limited to only three players. Additional players can be a part of the network and similar interactions can occur among any number of players.

In this embodiment, two of the players, both Player A and Player B can be playing the same network-based multiplayer video game on their respective PCs in a synchronous fashion. Player C can be playing a mobile game on his smartphone asynchronously with respect to the other two players (e.g., Player C is not playing in the same game session as Players A and B). All three players can be connected to a game server via one or more networks. The game server can record all three players' in-game behavior in a database and direct communications between the players when requested.

First, referring to FIG. 7, Player A can log into the multiplayer game from his PC to initiate a new game session or participate in an ongoing session (step 701). Once in the game session, Player A can play the game synchronously with one or more other players on the network (step 702). The other players can also play the game from their PCs or other gaming clients (e.g., game consoles, mobile devices, etc.) The game can be played in a synchronous fashion in which the players can play either cooperatively with each other or against each other in the same virtual environment.

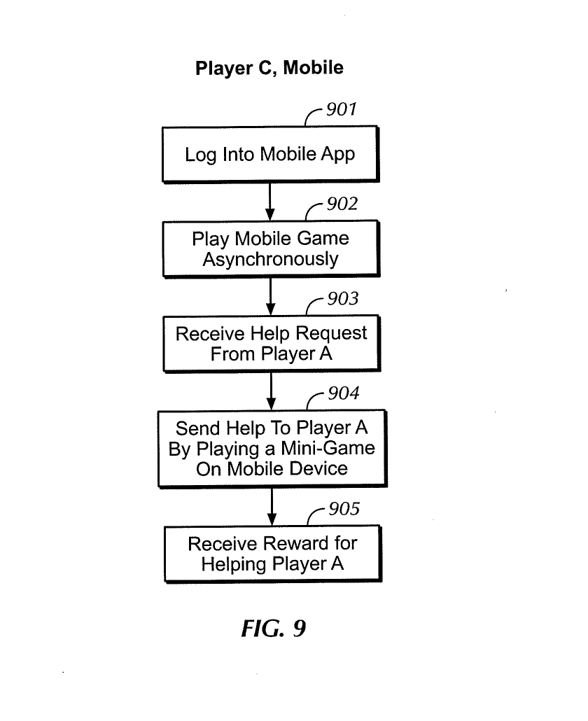

During the game, Player A can activate an in-game cooperation option when, for example, his health bar has fallen to a dangerous level (step 703). As previously discussed, in various embodiments, the game can be designed so that the cooperation option can become available when one or more conditions are met. After the cooperation option is activated, a request for cooperation can be sent via a central game server hosting the online game to all other players (e.g., Player A's friends) linked to Player A on the network (step 704). One or more of these friends (e.g., Player C) can choose to respond to Player A's cooperation request message, as to be discussed below in view of FIG. 9. As a result, Player A can receive cooperation from friends synchronously to improve his health or gain other advantages in the game (step 705). In return for his friends' cooperation, Player A can offer cooperation to them when they request for cooperation (step 706). Additionally or alternatively, Player A can, for example, visit friends' profiles to elevate their profiles on the network or cooperation them earn social currency.

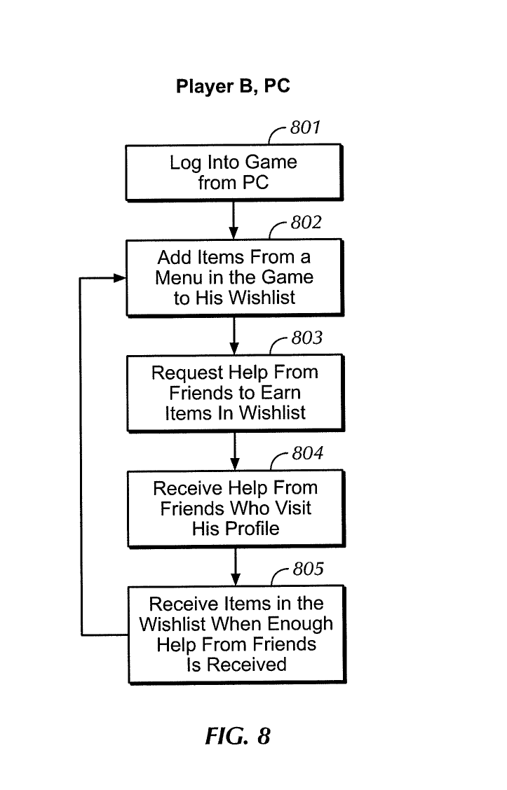

FIG. 8 illustrates the Player B's interaction with other players in the same game. First, Player B can log into the network-based multiplayer videogame from his PC (step 801). Before entering the game session, Player B can select one or more items from the main menu to be added to his wish list (step 802). The items can include any items, equipment, virtual currency, or skills that may give Player B an advantage in the game, but were not yet available to him based on his prior experience in the game. To gain access to one or more of the items in his wish list, Player B can reach out to his friends on the network and ask them for cooperation (step 803). In one embodiment, he can activate a cooperation option from the main menu to send out a message to all of his friends on the network.

Player B's message can be delivered to his friends' devices, requesting them to visit his profile on the network to help him earn credit towards the items in his wish list. When one or more of his friends visits his profile, they may be asked to play a mini-game embedded in the profile or perform other tasks. In return, Player B can receive credits that can be used to obtain the items in his wish list (step 804). When enough credits are accumulated, Player B can redeem them for one or more items for use in the game (step 805). Optionally, Player B's friends who offered cooperation may be rewarded with, for example, social currency. Player B can repeat the process illustrated in steps 802-805 to request for additional cooperation and be rewarded with more items for use in the game.

Unlike Players A and B who are both logged into the network-based game to play synchronously with other players, Player C can be playing a different game (e.g., a mobile version of the network game or a completely unrelated game) on his mobile device. As illustrated in FIG. 9, Player C can log into the mobile game on his device (step 901) and start playing the mobile game asynchronously with respect to the players playing the network-based multiplayer game (step 902). Thus, he may be unaware of other players' progress in their game(s). Nevertheless, his mobile device can still communicate with game server.

As Player C plays the mobile game, a cooperation alert can be received on his mobile device indicating that his friend, Player A is in need for cooperation in the multiplayer game (step 903). The cooperation alert can arrive in the form of a text message, email, ring tone, popup icon, tweet, or any other well-known means suitable for a mobile device. If Player C decides to help Player A, he can perform one or more tasks, which can be designated in the cooperation alert or preprogrammed in his device (step 904). For example, he can simply press an action button displayed in the text of the cooperation alert to send cooperation. Alternatively, he can start playing a mini-game or visit Player's A's online profile, as discussed in the embodiments above. As soon as he presses the action button (or performs any other requisite tasks), a signal can be transmitted from his mobile device to the game server, which in turn can immediately send cooperation to Player A. Alternatively, Player C can log into Player A's game session and provide cooperation by playing cooperatively with Player A. Through the above-described process, Player A can receive cooperation from Player C synchronously while playing the network game.

Optionally, Player C can receive certain reward for helping Player A (step 905). This may encourage Player C to continue to help his friends through the cooperation and gameplay system of the embodiments. For example, Player C can also help Player B, following similar steps shown in FIG. 9. A different task may be performed by Player C to earn credits for Player B. For example, instead of pressing an action button or playing a mini-game, Player C can visit Player B's profile to help him accumulate credits for the items in Player B's wish list.

Although FIGS. 7-9 illustrate Player C providing cooperation in response to Player A and Player B's requests, it should be understood that any of the three players or any other players on the network can both receive cooperation from other players and provide cooperation to other players through the disclosed cooperation and gameplay system. Preferably, the amount of cooperation a player receives is proportional to the number of his friends willing to respond to his cooperation request. This can encourage the players to actively make new connections and help each other as often as possible to achieve mutual success in the video games. In addition, as mentioned above, players can be rewarded with social currency and raise their profile and popularity in the online community by frequently helping other players.

Furthermore, embodiments of the invention can expand the reach of a conventional multiplayer gaming network by facilitating interactions among players who do not share the same type of gaming client, platform, or interest in games. As discussed in the various embodiments above, this can be achieved by providing a way for players to help other players without having to participate in the same game session. As such, any person on the network including those who are not gaming fans can respond to a player's request for cooperation by performing simple tasks on their own devices.

Although the embodiments described above are directed to help and gameplay systems for a multiplayer gaming network, the concept of the invention can be generalized and applied in other types of network communities. It should be understood that the context of these multi-user interactions is not limited to a gaming environment but can be easily applicable to other types of multi-user online environment that promotes the bonding of its members.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. A method for facilitating interactions between a first user and a second user connected to a network, comprising:
engaging the first user in a first activity over the network;
receiving a request for cooperation from the first user with regard to the first activity;
alerting the second user about the request from the first user;
receiving over the network feedback from the second user indicating progress in a second activity; and
providing cooperation to the first user with the first activity in response to the feedback received from the second user.

2. The method of claim 1, wherein the first activity and the second activity can be performed on different types of devices.

3. The method of claim 2, wherein the first activity is performed on a PC and the second activity is performed on a mobile device.

4. The method of claim 1, wherein the first activity and the second activity are performed synchronously.

5. The method of claim 1, wherein the cooperation is provided to the first user synchronously as the second user performs the second activity.

6. The method of claim 1, wherein the network is a multiplayer gaming network; and wherein the first activity is playing a game over the multiplayer gaming network.

7. The method of claim 6, wherein the second activity is unrelated to the game.

8. The method of claim 7, wherein the second activity is either playing a mobile app or visiting a profile of the first user.

9. The method of claim 6, wherein the cooperation provided is either changing one or more attributes in the game or making available one or more items for use in the game.

10. The method of claim 1, wherein the second user is alerted via one of a text message, email, voice alert, and tweet.

11. The method of claim 1, wherein the first user and the second user are the same user; and wherein the first activity and the second activity are performed asynchronously.

12. The method of claim 1, further comprising rewarding the second user in response to the cooperation received by the first user.

13. The method of claim 12, wherein the second user is rewarded with either virtual currency or an increase in his profile on the network.

14. The method of claim 1, further comprising alerting a third user on the network about the request from the first user; and
receiving over the network feedback from the third user indicating progress in a third activity.

15. The method of claim 14, wherein providing cooperation to the first user with the first activity is further in response to the feedback received from the third user.

16. A game server for facilitating interactions among a plurality of devices connected over a network, the game server configured to host a multiplayer game and perform the steps of:
initiating a session of the multiplayer game on a first device of the plurality of devices;
receiving a request for cooperation within the session from the first device;
determining one or more other devices associated with the first device;
transmitting a cooperation alert to the determined one or more other devices, requesting a task be performed at the other devices;
receiving feedback regarding the task from one or more of the other devices; and
determining whether to send cooperation to the first device in response to the received feedback,
wherein the task being performed on the other devices is unrelated to the session of the multiplayer game.

17. The game server of claim 16, further comprising a database server for maintaining a record of the received feedback.

18. The game server of claim 16, further comprising a database server for maintaining associations among the plurality of devices.

19. The game server of claim 16, wherein the first device is a PC and at least one of the determined other devices are mobile devices.

20. The game server of claim 16, wherein the task is performed synchronously as the session is ongoing.

21. The game server of claim 16, wherein the cooperation provided is either changing one or more attributes in the session or making available one or more items for use in the session.

22. The method of claim 16, wherein the cooperation alert is in the form of one of a text message, email, voice alert, and tweet.

23. The method of claim 1, wherein the task is performed asynchronously with respect to the session.
